(19) United States
(12) Patent Application Publication
(10) Pub. No.: US 2026/0260786 A1
(43) Pub. Date: Sep. 3, 2026

(54) ELECTRIC PROPULSION RADIO FREQUENCY SUPPLY COAXIAL CABLE

(71) Applicant: ArianeGroup GmbH, Taufkirchen (DE)

(72) Inventors: Nils RADERMACHER, Koblenz (DE); Jens HARTMANN, Zeven (DE)

(73) Assignee: ArianeGroup GmbH, Taufkirchen (DE)

(21) Appl. No.: 19/456,762

(22) Filed: Jan. 22, 2026

(30) Foreign Application Priority Data
Feb. 28, 2025 (EP) 25161077.0

(51) Int. Cl. H01B 11/18

(52) U.S. Cl. CPC H01B 11/1878; H01B 11/1813

(57) ABSTRACT

The present disclosure relates to a radio frequency, RF, coaxial cable to be used in an environment requiring transmission of a high alternating current, AC, with a high frequency, the RF coaxial cable comprising a single hollow inner conductor comprising a flexible metallic shielding. The present disclosure also relates to an RF coaxial cable to be used in an environment requiring transmission of a high AC with a high frequency, the RF coaxial cable consisting of a single hollow inner conductor comprising a flexible metallic shielding, an insulator on the single hollow inner conductor, an outer conductor on the insulator, wherein the outer conductor is formed of a second flexible metallic shielding, an outer sleeve on the outer conductor and an electromagnetic compatibility, EMC, overbraid on the outer sleeve.

### CROSS-REFERENCES TO RELATED APPLICATIONS

This application claims the benefit of the European patent application No. 25 161 007.0 filed on Feb. 18, 2025, the entire disclosure of which is incorporated herein by way of reference.

### FIELD OF THE INVENTION

The present disclosure generally relates to an electric propulsion radio frequency (RF) supply coaxial cable used for an environment requiring transmission of a high alternating current (AC) with a high frequency. In particular, the present disclosure relates to a loss-optimized, electric propulsion RF supply coaxial cable used in a complex environment that is demanding in terms of cable bending, radiation, temperature etc., such as for RF ion thrusters, preferably lattice ion thrusters.

### BACKGROUND OF THE INVENTION

FIG. 1 shows a system 1, such as a satellite, that comprises a coaxial cable 10, 10pa connecting an RF AC source 30 and a radio frequency ion thruster (RIT) 20.

The RF current source 30 may be an inverter for transforming direct current (DC), e.g. from a corresponding satellite bus, into a high frequency/RF AC, such as an RF generator (RFG). The RIT 20 may be a thruster for translationally propelling/accelerating a satellite along any axis of a three-dimensional coordinate system and/or for rotationally propelling/accelerating the satellite around any of the axes (yaw, pitch and/or roll) of the three-dimensional coordinate system; in addition or alternatively, the RIT 20 may perform plasma generation and acceleration via a lattice system.

FIG. 2A shows a coaxial cable 10pa according to the prior art.

For the operation of the RIT 20, high currents have to be transmitted at high frequencies. In the prior art, as is shown in FIG. 2A, coaxial cables 10pa are generally used for this purpose, which comprise of a forward conductor/inner conductor 101pa in the core and a concentrically arranged return conductor/outer conductor 103pa with an insulation/insulator 102pa in-between them. The coaxial cable 10pa may further comprise an outer sleeve 104pa.

The aforementioned transmission of ACs at high frequencies is highly lossy, as effects occur in this operating range that greatly reduce the effective cross-section of an electrical conductor effectively utilised by the AC. This effect primarily manifests itself in the fact that the flowing current is “displaced” towards the edge layers of the conductor (so-called skin effect). Conventional cables 10pa for RF applications with a coaxial structure often use so-called Litz cables (or strand cables) in conductor bundles/strands 101pa-str (of which 3 are connected to the reference sign as examples) in the core 101pa in order to minimise losses. These strands 101pa-str may have relatively small diameters dₛ, which means that the aforementioned effects are less pronounced.

However, the disadvantage is that a large number of strands 101pa-str is required to transmit a suitable current. In tightly packed bundles, the advantage of the lower severity of the skin effect is partially relativized by displacement effects that now occur between those strands 101pa-str having the same potential (so-called proximity effect). Due to the high number of strands 101pa-str, such cables 10pa also have a high bending stiffness, which means that they are not always suitable for use e.g. on a swivelling thruster.

FIG. 2B shows a graph pertaining to conventional RF coaxial cables 10pa plotting an overall outer diameter of the coaxial cable 10pa on the abscissa vs. a cable core/shell temperature gradient on the ordinate.

As is shown in FIGS. 2A and 2B, another disadvantage of conventional RF coaxial cables 10pa resides the effect of the often-small overall diameter dₒ (abscissa in FIG. 2B, see also FIG. 2A) on the temperatures/temperature gradients (ordinate in FIG. 2B) that occur during operation. Two sample values are shown with dashed lines at 14.6 mm cable core diameter (denoted “heritage”) and at 19.1 mm cable core diameter. At the first named value, an RF coaxial cable having a core diameter of 3.37 mm and a core/shell gradient of 90 K currently used with a thruster is shown, which reaches temperatures above the material limit, while at the latter-named value, an ideal example case (idealized in that in reality, the capacitance will also increase) is shown that describes the benefit of a larger core diameter (i.e., 7.87 mm vs. above-shown 3.37 mm) while maintaining all other material thicknesses, thus reducing the core/shell gradient from the above-shown 90 K to 50 K.

On the one hand, diameter reductions are necessary to guarantee the mechanical flexibility of the cable 10pa. On the other hand, however, this limitation means that the resulting small diameter of the inner conductor leads to a very small contact surface with the subsequent layers (insulation material/insulator 102pa). As a result, the heat \dot{q}_{core} generated in the outgoing conductor 101pa can only be dissipated to the outside to a limited extent—as a result, “heat build-up” occurs in the cable core 101pa, which leads to a high temperature gradient (see ordinate in FIG. 2B) and thus the heat transfer between the core 101pa (\dot{q}_{core}) and the surface/outer sleeve 104pa (\dot{q}ᵣₜₙ) of the cable 10pa (\dot{q}ₜₒₜ) may be insufficient.

### SUMMARY OF THE INVENTION

Accordingly, there is a need for an implementation of an improved coaxial cable suitable for environments of a high AC with a high frequency, such as RF ion thrusters, preferably lattice ion thrusters.

These objects are solved by the present invention as defined by the independent claims. Preferred embodiments are defined by the dependent claims.

Without loss of generality, the present disclosure can be summarized as follows:

The present cable as the subject of the invention disclosure adopts an alternative approach and combines the necessary reduction of the losses arising during transmission with a high degree of mechanical flexibility and also achieves a significantly lower temperature gradient between the forward conductor in the core and the cable surface.

A specific geometric structure in combination with suitable materials is used for this purpose. Instead of many bundled strands for the forward conductor, as in conventional RF cables, a single waveguide/hollow conductor is used, as is common in the remote field of static conductors, for example in antenna technology in the form of tubes. This has the advantage over stranded wires that losses due to the proximity effect of neighbouring conductors of the same potential do not occur by design. The hollow conductor also has the advantage that it can be optimally designed for the current distribution caused by the skin effect (high current density in the edge layers). The utilisation of the available conductor cross-sectional area can therefore be maximised and the conductor material—that is not required because no current flows through it—can be minimised. However, as the hollow conductor tubes used are rigid and therefore not suitable for this purpose, a flexible, metallic shielding is used in this case. In order to hold this shielding in position in the structure, it is mounted on a plastic shaper. This shaper is hollow in order to minimise the bending stiffness of the structure. The return conductor in this design is also designed as a shielding, as is usual in coaxial cables.

Another disadvantage of conventional RF cables is the effect of the often small overall diameter on the temperatures that occur during operation. Diameter reductions are necessary to guarantee the mechanical flexibility of the cable. At the same time, however, this limitation means that the resulting small diameter of the inner conductor leads to a very small contact surface with the subsequent layers (insulation material). As a result, the heat generated in the outgoing conductor can only be dissipated to the outside to a limited extent and a “heat build-up” occurs in the cable core, which leads to a high temperature gradient between the core and the surface of the cable. The central point of the new cable described is therefore the selected diameter of the inner conductor shielding. Said diameter is designed to achieve a compromise/optimum between low power dissipation, good/high heat dissipation in the radial direction and a low capacitance per unit length. The latter is essential for the specific application in the resonance circuit of the RIT thruster.

In addition, the present disclosure enables the following advantages:
Enabling an optimized cable design by means of the combination of a hollow core/hollow conductor (e.g. supported by a plastic shaper) and the selection of a suitable insulation material between the forward and return conductors with low mechanical stiffness and good electrical properties
Increasing diameter of the forward conductor compared to conventional cables without resulting in a significant increase in bending stiffness
Maximizing effective conductor cross-sectional area effectively used by the AC by using metallic shieldings as the hollow conductor
Significantly improving heat dissipation from the cable core to the outside
Reducing losses and temperatures and enabling a high degree of flexibility/low bending stiffness to be realised for the RF cable, which is a fundamental prerequisite for the successful operation in an environment requiring transmission of a high AC with a high frequency, such as the RIT.

In a first aspect to better understand the present disclosure, there is provided a radio frequency, RF, coaxial cable to be used in an environment requiring transmission of a high alternating current, AC, with a high frequency, the RF coaxial cable comprising a single hollow inner conductor comprising a flexible metallic shielding.

In a first refinement of the first aspect, the flexible metallic shielding is preferably made of a Ni—Cu-braid or an Ag—Cu-braid.

In a second refinement of the first aspect, the RF coaxial cable preferably further comprises an insulator on the single hollow inner conductor. The insulator is preferably made of silicone rubber, particularly preferably vinylmethylsilicone rubber. Moreover, the RF coaxial cable preferably further comprises an outer conductor on the insulator, wherein the outer conductor is preferably formed of a second flexible metallic shielding, an outer sleeve on the outer conductor and an electromagnetic compatibility, EMC, overbraid on the outer sleeve. In this regard, the second flexible metallic shielding is preferably made of a Ni—Cu-braid or an Ag—Cu-braid, and/or the outer sleeve is preferably made of a non-metallic tubular braid and/or the EMC overbraid is preferably made of a Ni—Cu-braid or an Ag—Cu-braid.

In a third refinement of the first aspect, the single hollow inner conductor preferably consists of the flexible metallic shielding and a hollow shaper that maintains the shape of the flexible metallic shielding in that the flexible metallic shielding is provided in the manner of a sheath on the hollow shaper. In the latter case, the hollow shaper preferably is a hollow plastics shaper, particularly preferably an inner tube made of silicone rubber, most particularly preferably an inner tube made of vinylmethylsilicone rubber.

In a fourth refinement of the first aspect, the single hollow inner conductor preferably has a diameter, d₁, selected to provide a low capacitance per unit length of the RF coaxial cable. In the latter case, the low capacitance per unit length preferably is lower than 160 pF/m. In addition or alternatively, d₁ is preferably further selected to reach an optimum between the low capacitance per unit length, low power dissipation, high heat dissipation in radial direction of the RF coaxial cable and low inductance per unit length. In the latter case, the low power dissipation preferably is in a range lower than 7.7 W/m, particularly preferably between 2.4 W/m and 6.8 W/m, wherein most preferably, the low power dissipation is achieved by a AC resistance per unit length in a range lower than 30.0 mΩ/m for a reference frequency (e.g. 750 kHz), the high heat dissipation preferably is higher than 1.0 W/K and the low inductance per unit length is preferably in a range lower than 220 nH/m. In addition or alternatively, d₁ preferably is in a range between 4.0 mm and 8.5 mm, particularly preferably in a range between 4.5 mm and 8.2 mm.

In a fifth refinement of the first aspect, the environment preferably is an RF ion thruster, especially preferably a lattice ion thruster. In the latter case, the environment preferably involves a high AC in a range between 25 A to 50 A peak-peak and a high frequency in a range between 500 kHz to 900 kHz.

In a second aspect of to better understand the present disclosure, there is provided a radio frequency, RF, coaxial cable to be used in an environment requiring transmission of a high alternating current, AC, with a high frequency, the RF coaxial cable consisting of a single hollow inner conductor comprising a flexible metallic shielding, an insulator on the single hollow inner conductor, an outer conductor on the insulator, wherein the outer conductor is formed of a second flexible metallic shielding, an outer sleeve on the outer conductor; and an electromagnetic compatibility, EMC, overbraid on the outer sleeve.

Still further, the second aspect preferably includes the properties of any of the above-described first to fifth refinements of the first aspect.

### BRIEF DESCRIPTION OF THE DRAWINGS

The embodiments of the technique presented herein are described herein below with reference to the accompanying drawings, in which:

FIG. 1 shows a system (such as a satellite) that comprises a coaxial cable connecting an RF AC source and a radio frequency ion thruster (RIT);

FIG. 2A shows a coaxial cable 10pa according to the prior art;

FIG. 2B shows a graph pertaining to conventional RF coaxial cables 10pa plotting an overall outer diameter of the coaxial cable 10pa on the abscissa vs. a cable core/shell temperature gradient on the ordinate;

FIG. 3 shows an embodiment of the electric propulsion RF supply coaxial cable according to the present disclosure;

FIG. 4A shows properties (radii/diameter of the components/layers used) of the electric propulsion RF supply coaxial cable according to the present disclosure vs. the obtainable capacitance per unit length;

FIG. 4B shows the properties (radii/diameter of the components/layers used) of the electric propulsion RF supply coaxial cable according to the present disclosure vs. the obtainable inductance per unit length, resistance per unit length, power dissipation, heat dissipation and core temperature in a reference flight case (i.e., space) defined as 1400 W/m² solar radiation and 30° C. thermal environment temperature in vacuum;

FIG. 5A shows test results in terms of the core temperature (referring to measurements conducted in a vacuum test chamber (on the ground) without any solar radiation and a 30° C. thermal environment temperature) for three use cases OP-1 (low power mode), OP-2 (high current mode) and OP-3 (maximum thrust mode) pertaining to the electric propulsion RF supply coaxial of the present disclosure; and

FIG. 5B shows test results in terms of the power dissipation for the three use cases OP-1 (low power mode), OP-2 (high current mode) and OP-3 (maximum thrust mode) pertaining to the electric propulsion RF supply coaxial of the present disclosure.

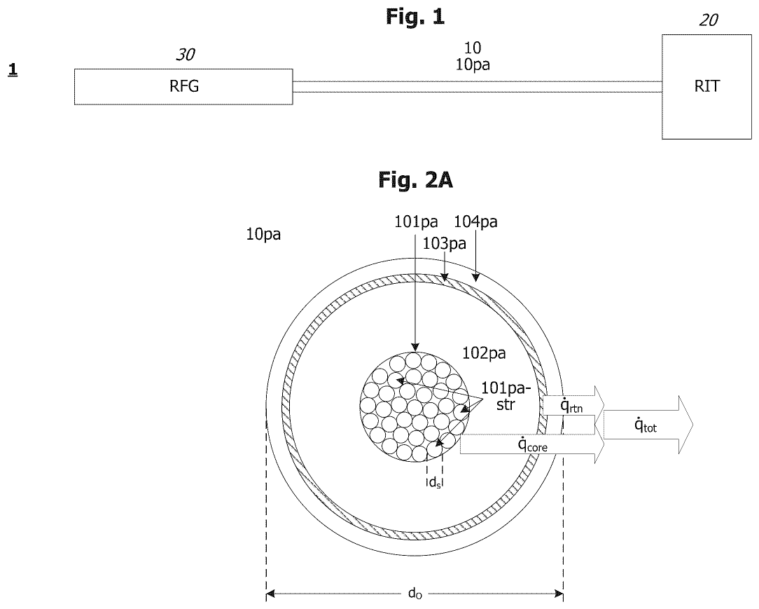

### DETAILED DESCRIPTION OF PREFERRED EMBODIMENTS

In the following description, for purposes of explanation and not limitation, specific details are set forth in order to provide a thorough understanding of the technique presented herein. It will be apparent to one skilled in the art that the present technique may be practiced in other embodiments that depart from these specific details.

Moreover, those skilled in the art will appreciate that the services, functions and steps explained herein may be implemented using software functioning in conjunction with a programmed microprocessor or using an Application Specific Integrated Circuit (ASIC), a Digital Signal Processor (DSP) or general-purpose computer. It will also be appreciated that while the following embodiments are described in the context of methods and devices, the technique presented herein may also be embodied in a computer program product as well as in a system comprising a computer processor and a memory coupled to the processor, wherein the memory is encoded with one or more programs that execute the services, functions and steps disclosed herein. This applies especially to the aspects of (i) an automated process for manufacturing/forming the loss-optimized RF coaxial cable of the present disclosure and of (ii) simulation processes for the loss-optimized RF coaxial cable of the present disclosure.

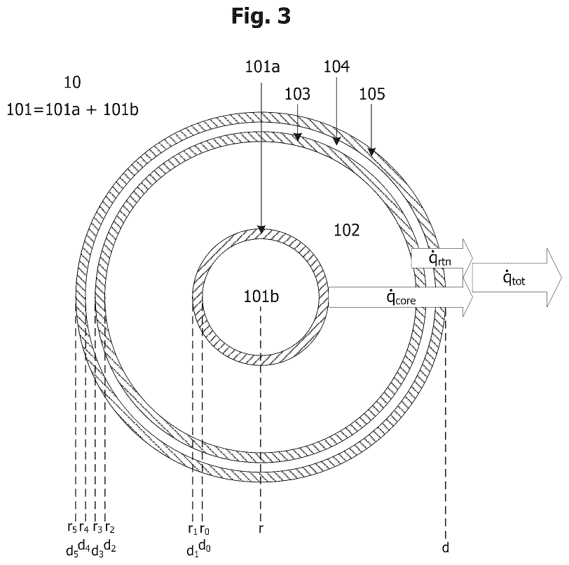

FIG. 3 shows an embodiment of the electric propulsion RF supply coaxial 10 according to the present disclosure to be used in an environment requiring transmission of a high AC with a high frequency. In general, the electric propulsion RF supply coaxial 10 of the present disclosure adopts an alternative approach and combines the necessary reduction of losses (such as power losses) arising during transmission with a high degree of mechanical flexibility and also achieves a significantly lower temperature gradient between the forward conductor 101a in the core 101 and the cable surface 104.

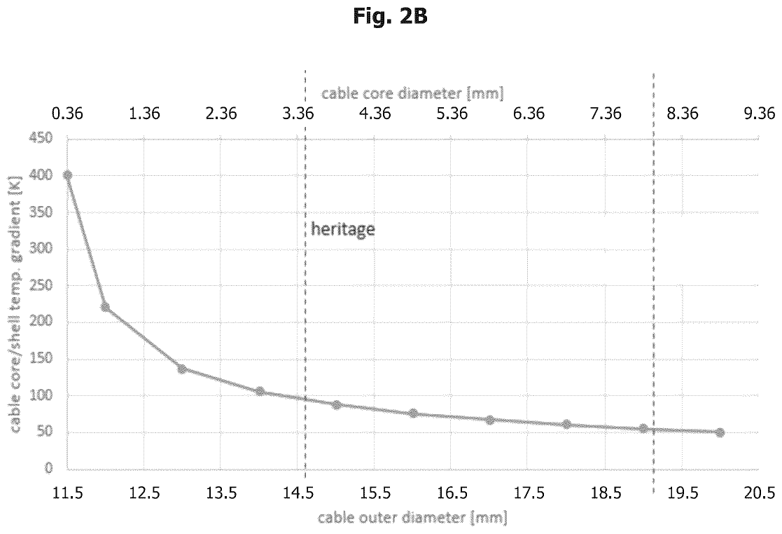

To this end, the electric propulsion RF supply coaxial 10 (simply “RF coaxial cable 10” hereinafter) comprises a single hollow inner conductor 101 comprising a flexible metallic shielding 101a. That is, a specific geometric structure in combination with suitable materials (to be further described below) is used for this purpose. Instead of many bundled strands 101pa-str for the forward conductor 101pa (see FIG. 2A), as in conventional RF cables 10pa, a single waveguide/hollow conductor 101 is used—a somewhat comparable structure is only found in remote technical fields, such as in static conductors, for example in antenna technology in the form of tubes. This has the advantage over stranded wires 101pa-str that losses due to the above-described proximity effect of neighbouring conductors of the same potential do not occur by design. Moreover, the hollow conductor 101 also has the advantage that it can be optimally designed for current distribution caused by the above-described skin effect (i.e., high current density in the edge layers). The utilisation of the available conductor cross-sectional area can therefore be maximised and the conductor material—that is not required because no current flows through it—can be minimised. However, as the previously used hollow conductor tubes 101pa used are rigid and therefore not suitable for the environment of the present disclosure, the flexible metallic shielding 101a is used in this case.

In this regard, the flexible metallic shielding 101a is preferably made of a Ni—Cu-braid or an Ag—Cu-braid. The present disclosure is not to be limited to a specific type of braid. Other material combinations are feasible based on the present disclosure—as a non-limiting example, a nickel plated copper braid with minimum optical coverage of 93% for temperatures above 150° C. may be used.

Moreover, the RF coaxial cable 10 preferably further comprises an insulator 102 on the single hollow inner conductor 101 (or, more precisely, on the flexible metallic shielding). Note in this regard that when the present disclosure describes one layer to be “on” another layer, this is to be interpreted as a substantially complete areal/circumferential contact between said layers—this does, however, not restrict the manner/method for manufacture of such a layered compound in any way: (i) one layer (e.g. a braid) can be pulled over, in the manner of sheath, over another layer, (ii) one layer, such as a (plastics) sleeve, could be laminated with another layer, (iii) one layer, such as a (plastics) sleeve, could be coated on another layer and (iv) adhesives/adhesive layer(s) (or similar merely function layer(s), not shown) could also be provided between two layers of the present disclosure, where necessary (in other words, the scope of protection of the present disclosure cannot be circumvented by sandwiching one or more adhesive layers, or similar merely functional layer(s), between two layers defined in the present disclosure).

Moreover, the insulator 102 is preferably made of silicone rubber, particularly preferably vinylmethylsilicone rubber. Additionally, the RF coaxial cable 10 preferably further comprises (i) an outer conductor 103 on the insulator 102, wherein the outer conductor 103 is preferably formed of a second flexible metallic shielding 103, (ii) an outer sleeve 104 on the outer conductor 103 and (iii) an EMC overbraid 105 on the outer sleeve 104.

In this regard, the second flexible metallic shielding 103 is preferably made of a Ni—Cu-braid or an Ag—Cu-braid.

In addition or alternatively, the outer sleeve 104 is preferably made of a non-metallic tubular braid. In a non-restricting example, said non-metallic tubular braid may be a flame-resistant fabric using meta-aramid chemistry, para-aramid (Kevlar) chemistry or other insulating materials.

In addition or alternatively, the EMC overbraid 105 is preferably made of a Ni—Cu-braid or an Ag—Cu-braid (described above).

Moreover, the single hollow inner conductor 101 preferably consists of (i.e., no further features are present in the single hollow inner conductor 101 apart from the ones following) the flexible metallic shielding 101a and a hollow shaper 101b that preferably maintains the shape of the flexible metallic shielding 101a in that the flexible metallic shielding 101a is provided in the manner of a sheath on the hollow shaper 101b. As noted above, while it may be practical to pull the flexible metallic shielding 101a over the hollow shaper 101b, this does not rule out any other feasible method of manufacture for providing the single hollow inner conductor 101, such as plating or weaving.

In this regard, the hollow shaper 101b preferably is a hollow plastics shaper, particularly preferably an inner tube made of silicone rubber and most particularly preferably an inner tube made of vinylmethylsilicone rubber. That is, in order to hold the flexible metallic shielding 101a in position in the overall structure of the RF coaxial cable 10, said shielding 101a is preferably mounted on said plastic shaper 101b. Said shaper 101b is preferably hollow in order to minimise the bending stiffness of the overall structure of the RF coaxial cable 10.

Still further, it goes without saying that any of the single hollow conductor 101 (hollow shaper 101b and flexible metallic shielding 101a), the insulator 102, the outer conductor 103, the outer sleeve 104 and the EMC overbraid 105 preferably have a (substantially) cylindric shape that are concentric with respect to a common center, as is commonplace for coaxial cables. Accordingly, the hollow shaper 101b has a radius r₀ or diameter d₀, the flexible metallic shielding 101a (or single hollow conductor 101 as a whole) has a radius r₁ or diameter d₁, the insulator 102 has a radius r₂ or diameter d₂, the outer conductor 103 has a radius r₃ or diameter d₃, the outer sleeve 104 has a radius r₄ or diameter d₄ and the EMC overbraid 105 has a radius r₅ or diameter d₅.

In this regard, the diameter d₁ of the single hollow inner conductor 101 is preferable selected to provide a low capacitance per unit length of the RF coaxial cable 10. Another disadvantage of conventional RF cables 10pa is the effect of the often-small overall diameter d_{O} on the temperatures that occur during operation (see FIG. 2A). On the one hand, diameter reductions are necessary to guarantee the mechanical flexibility of the cable. On the other hand, however, this limitation means that the resulting small diameter of the inner conductor 101pa leads to a very small contact surface with the subsequent layers (insulation material/isolator 102pa). As a result, heat generated in the outgoing conductor/inner conductor 101pa can only be dissipated to the outside to a limited extent and a “heat build-up” occurs in the cable core 101pa, which leads to a high temperature gradient between the core 101pa and the surface (e.g. outer sleeve 104pa) of the RF coaxial cable 10pa. One particular feature of the RF coaxial cable 10 of the present disclosure therefore resides in the selected diameter d₁ of the inner conductor shielding 101a. Said diameter d₁ is designed to achieve a compromise/optimum between low power dissipation, good/high heat dissipation in the radial direction, a low capacitance per unit length of the RF coaxial cable 10. Said low capacitance per unit length is particularly important for the environment of the present disclosure, i.e., the environment preferably being (a resonance circuit of) an RF ion thruster, particularly preferably a lattice ion thruster. Said environment preferably involves a high AC in a range between 25 A to 50 A peak-peak and a high frequency in a range between 500 kHz to 900 kHz.

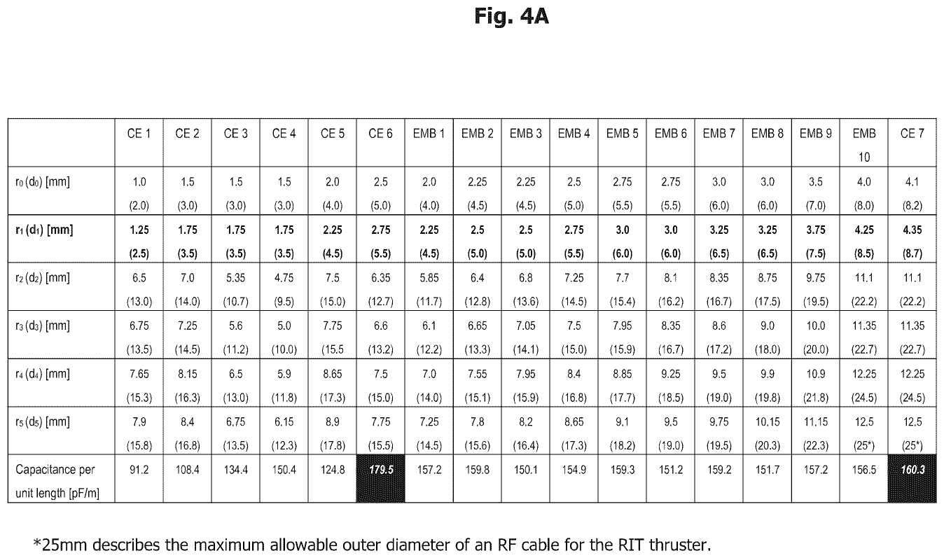

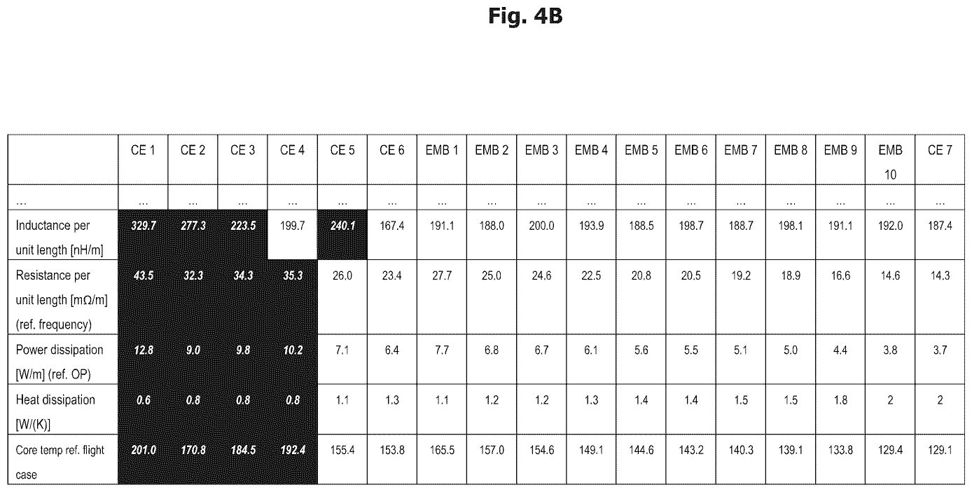

FIG. 4A shows properties (radii/diameter of the components/layers used) of the electric propulsion RF supply coaxial cable according to the present disclosure vs. the obtainable capacitance per unit length, while FIG. 4B shows the properties (radii/diameter of the components/layers used) of the electric propulsion RF supply coaxial cable according to the present disclosure vs. the obtainable inductance per unit length, resistance per unit length, power dissipation, heat dissipation and core temperature in a reference flight case (i.e., space) defined as 1400 W/m² solar radiation and 30° C. thermal environment temperature in vacuum.

As is seen in FIGS. 4A and 4B, comparative examples 1 to 7 (abbreviated “CE 1” to “CE 7”) show properties r₀ to r₅ (d₀ to d₅) leading to values of capacitance per unit length, inductance per unit length, resistance per unit length, power dissipation, heat dissipation (such as heat dissipation between inner core conductor and insulating material) and core temperature below/above the claimed ranges (highlighted in black boxes in FIGS. 4A and 4B). In turn, embodiments 1 to 10 (abbreviated “EMB 1” to “EMB 10”) show properties r₀ to r₅ (d₀ to d₅) leading to values of capacitance per unit length, inductance per unit length, resistance per unit length, power dissipation, heat dissipation (such as heat dissipation between inner core conductor and insulating material) and core temperature inside the claimed ranges. Notably, both embodiment 10 (EMB 10) and comparative example 7 (CE 7) are special in that they show the extreme case of d₅ being 25.0 mm, i.e., the maximum allowable outer diameter of an RF cable 10 for application in the RIT.

As shown in FIG. 4A, the low capacitance per unit length is preferably in a range lower than 160 pF/m.

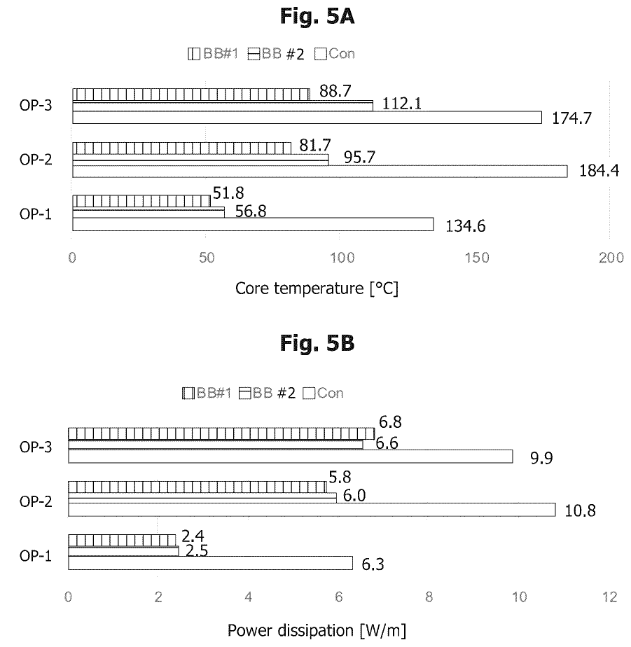

As is shown in FIGS. 4A and 4B, the diameter d₁ (of the single hollow inner conductor 101/flexible metallic sheet 101a) is preferably further selected to reach an optimum between the low capacitance per unit length, low power dissipation, high heat dissipation in radial direction of the RF coaxial cable 10 and low inductance per unit length. That is, as shown in FIG. 4B (and in FIG. 5B described below), the low power dissipation preferably is in a range lower than 7.7 W/m, preferably between 2.4 W/m and 6.8 W/m (e.g. depending on a thruster operational point (OP), preferably a state lower than 7.7 W/m over all OPs (see FIGS. 4A and 4B described above)), as is shown in FIG. 4B (and in FIG. 5A), the high heat dissipation preferably is in a range higher than 1.0 W/K and the low inductance per unit length preferably is in a range lower than 220 nH/m.

As is also shown in FIGS. 4A and 4B, the diameter d₁ (of the single hollow inner conductor 101/flexible metallic sheet 101a) is preferably further selected to reach also an optimum with respect to low resistance per unit length and low core temperature (for the latter, in a different scenario, see also FIG. 5A). That is, the low resistance per unit length preferably is in a range lower than 30.0 mΩ/m for a reference frequency (e.g. 750 kHz), thus enabling the low power dissipation, and the low core temperature preferably is in a range below 170° C. (in a reference flight case, i.e., space, defined as 1400 W/m² solar radiation and 30° C. thermal environment temperature in vacuum, see FIG. 4B) or preferably in a range below 120° C. (referring to measurements conducted in a vacuum test chamber (on the ground) without any solar radiation and a 30° C. thermal environment temperature, see FIG. 5A).

Ultimately, the important parameter d₁ (diameter of the single hollow inner conductor 101/of the flexible metallic shielding 101a) is thus preferably in a range between 4.0 mm and 8.5 mm, particularly preferably in a range between 4.5 mm and 8.2 mm (as is shown in FIG. 4A in bold print).

FIG. 5A shows test results in terms of the core temperature (referring to measurements conducted in a vacuum test chamber (on the ground) without any solar radiation and a 30° C. thermal environment temperature) for three use cases OP-1 (low power mode), OP-2 (high current mode) and OP-3 (maximum thrust mode) pertaining to the RF coaxial cable 10 of the present disclosure, while FIG. 5B shows test results in terms of the power dissipation for the three use cases OP-1 (low power mode), OP-2 (high current mode) and OP-3 (maximum thrust mode) pertaining to the RF coaxial cable 10 of the present disclosure.

FIGS. 5A and 5B respectively show 2 samples (dubbed breadboard (BB), i.e. “breadboard” and refers to a prototype model built for testing purposes), denoted “BB #1” and “BB #2”, of RF coaxial cables 10 evaluated vs. a prior art RF coaxial cable 10pa (denoted “Con”(ventional)). As is seen in FIG. 5A, the samples BB #1 and BB #2 compare, for all three use cases, favourably to the prior art in terms keeping the core temperature of the inner conductor 101 below 120° C. (without considering ambient influences, such as sun radiation). Moreover, as is seen in FIG. 5B, the samples BB #1 and BB #2 compare, for all three use cases, favourably to the prior art in terms keeping the power dissipation of the overall RF coaxial cable 10 below 7.7 W/m (over all above-described OPs).

In an alternative implementation, the RF coaxial cable 10 to be used in said environment requiring transmission of the high AC with a high frequency may consist of (i.e., no further features are present in the RF coaxial cable 10 apart from the ones following): a single hollow inner conductor 101 (preferably including any of the above-described properties) comprising a flexible metallic shielding 101a (preferably including any of the above-described properties), an insulator 102 (preferably including any of the above-described properties) on the single hollow inner conductor, an outer conductor 103 (preferably including any of the above-described properties) on the insulator, wherein the outer conductor is formed of a second flexible metallic shielding (preferably including any of the above-described properties), an outer sleeve 104 (preferably including any of the above-described properties) on the outer conductor and an EMC overbraid 105 (preferably including any of the above-described properties) on the outer sleeve.

It is believed that the advantages of the technique presented herein will be fully understood from the foregoing description, and it will be apparent that various changes may be made in the form, constructions and arrangement of the exemplary aspects thereof without departing from the scope of the present disclosure or without sacrificing all of its advantageous effects. Because the technique presented herein can be varied in many ways, it will be recognized that the present disclosure should be limited only by the scope of the claims that follow.

What is claimed is:

1. A radio frequency, RF, coaxial cable to be used in an environment requiring transmission of a high alternating current, AC, with a high frequency, the RF coaxial cable comprising:
a single hollow inner conductor comprising a flexible metallic shielding.

2. The RF coaxial cable of claim 1, wherein:
the flexible metallic shielding is made of a Ni—Cu-braid or an Ag—Cu-braid.

3. The RF coaxial cable of claim 1, wherein the RF coaxial cable further comprises:
an insulator on the single hollow inner conductor.

4. The RF coaxial cable of claim 3, wherein:
the insulator is made of silicone rubber, preferably vinylmethylsilicone rubber.

5. The RF coaxial cable of claim 3, wherein the RF coaxial cable further comprises:
an outer conductor on the insulator, wherein the outer conductor is formed of a second flexible metallic shielding;
an outer sleeve on the outer conductor; and
an electromagnetic compatibility, EMC, overbraid on the outer sleeve.

6. The RF coaxial cable of claim 5, wherein:
the second flexible metallic shielding is made of a Ni—Cu-braid or an Ag—Cu-braid; and/or
the outer sleeve is made of a non-metallic tubular braid; and/or
the EMC overbraid is made of a Ni—Cu-braid or an Ag—Cu-braid.

7. The RF coaxial cable of claim 1, wherein:
the single hollow inner conductor consists of:
the flexible metallic shielding; and
a hollow shaper that maintains the shape of the flexible metallic shielding in that the flexible metallic shielding is provided in the manner of a sheath on the hollow shaper.

8. The RF coaxial cable of claim 7, wherein:
the hollow shaper is a hollow plastics shaper, preferably an inner tube made of silicone rubber, particularly preferably an inner tube made of vinylmethylsilicone rubber.

9. The RF coaxial cable of claim 1, wherein:
the single hollow inner conductor has a diameter, d₁, selected to provide a low capacitance per unit length of the RF coaxial cable.

10. The RF coaxial cable of claim 9, wherein:
the low capacitance per unit length is lower than 160 pF/m.

11. The RF coaxial cable of claim 9, wherein:
d₁ is further selected to reach an optimum between the low capacitance per unit length, low power dissipation, high heat dissipation in radial direction of the RF coaxial cable and low inductance per unit length.

12. The RF coaxial cable of claim 11, wherein:
the low power dissipation is in a range lower than 7.7 W/m, preferably between 2.4 W/m and 6.8 W/m, wherein particularly preferably, the low power dissipation is achieved by a AC resistance per unit length in a range lower than 30.0 mΩ/m for a reference frequency;
the high heat dissipation is in a range higher than 1.0 W/K; and
the low inductance per unit length is in a range lower than 220 nH/m.

13. The RF coaxial cable of claim 9, wherein:
d₁ is in a range between 4.0 mm and 8.5 mm, preferably in a range between 4.5 mm and 8.2 mm.

14. The RF coaxial cable of claim 1, wherein:
the environment is an RF ion thruster, preferably a lattice ion thruster.

15. The RF coaxial cable of claim 14, wherein:
the environment involves:
a high AC in a range between 25 A to 50 A peak-peak; and
a high frequency in a range between 500 kHz to 900 kHz.

16. A radio frequency, RF, coaxial cable to be used in an environment requiring transmission of a high alternating current, AC, with a high frequency, the RF coaxial cable consisting of:
a single hollow inner conductor comprising a flexible metallic shielding;
an insulator on the single hollow inner conductor;
an outer conductor on the insulator, wherein the outer conductor is formed of a second flexible metallic shielding;
an outer sleeve on the outer conductor; and
an electromagnetic compatibility, EMC, overbraid on the outer sleeve.

17. The RF coaxial cable of claim 16, wherein the flexible metallic shielding is made of a Ni—Cu-braid or an Ag—Cu-braid.
